(19) United States
(12) Patent Application Publication
(10) Pub. No.: US 2005/0088405 A1
(43) Pub. Date: Apr. 28, 2005

(54) Portable electronic device

(75) Inventors: Chien-Ming Chu, Taipei Hsien (TW); Yu-Cheng Hua, Taipei Hsien (TW); Wan-Chi Lan, Taipei Hsien (TW)

Correspondence Address: LADAS & PARRY, 5670 WILSHIRE BOULEVARD, SUITE 2100, LOS ANGELES, CA, 90036-5679, US

(73) Assignee: WISTRON CORPORATION

(21) Appl. No.: 10/764,034

(22) Filed: Jan. 23, 2004

(30) Foreign Application Priority Data
Oct. 22, 2003 (TW) 092129465

(51) Int. Cl. G09G 5/00

(52) U.S. Cl. 345/156

(57) ABSTRACT

A portable electronic device includes a pivot unit coupled to a main housing and a cover body such that the cover body is pivotable about a longitudinal axis parallel to a top surface of the main housing, and about a vertical axis transverse to the top surface of the main housing. A virtual control key module configures a display panel mounted on a first surface of the cover body to show simulated control keys thereon when the portable electronic device is operated in a mode, where the cover body is superimposed on the main housing such that a second surface of the cover body opposite to the first surface faces toward the top surface of the main housing. The simulated control keys have distinct functions assigned thereto and are available for selection so as to enable execution of the function assigned to a selected simulated control key.

### CROSS-REFERENCE TO RELATED APPLICATION

This application claims priority of Taiwanese Application No. 092129465, filed on Oct. 22, 2003.

### BACKGROUND OF THE INVENTION

1. Field of the Invention

The invention relates to a portable electronic device, more particularly to a portable electronic device, such as a notebook computer, that can be operated in a tablet mode.

2. Description of the Related Art

Referring to FIGS. 1 to 3, a conventional portable electronic device 1, such as a notebook computer, is shown to include a main housing 10, a cover body 11 and a pivot unit 17. The main housing 10 has opposite front and rear ends 101, 100, and a top surface 12 provided with a keyboard unit 13 thereon. The keyboard unit 13 includes number keys (1, 2, 3, . . . , 0), alphabet keys (A, B. C, . . . , Z), symbol keys (<, >, +, ?, . . . ), and a number of control keys (F1˜F12, Tab, Esc, Ctrl, . . . ), etc. The cover body 11 has a coupling side 110, and opposite first and second surfaces 14, 15. The first surface 15 is provided with a touch-control display panel 16 thereon. The pivot unit 17 is coupled to the rear end 100 of the main housing 10 and the coupling side 110 of the cover body 11 such that the cover body 11 is pivotable about a longitudinal axis (X), which is parallel to the top surface 12 of the main housing 10, and about a vertical axis (Y) transverse to the top surface 12 of the main housing 10 (see FIG. 1), thereby permitting operation of the portable electronic device in one of a first mode, where an angle is formed between the top surface 12 of the main housing 10 and the first surface 14 of the cover body 11 and where the cover body 11 permits access to the keyboard unit 13, as shown in FIG. 1, and a second (or tablet) mode, where the cover body 11 is superimposed on the main housing 10 such that the second surface 15 of the cover body 11 faces toward the top surface 12 of the main housing 10 and such that the cover body 11 denies access to the keyboard unit 13, as shown in FIG. 3.

The portable electronic device 1 can serve as a tablet computer when in the second mode. Although data can be inputted by handwriting or pressing operation via the touch-control display panel 16, it is necessary to raise the cover body 11 for operation of the control keys on the keyboard unit 13, thereby resulting in inconvenience during use.

### SUMMARY OF THE INVENTION

Therefore, the object of the present invention is to provide a dual-mode portable electronic device that is capable of overcoming the aforesaid drawbacks of the prior art.

According to the present invention, a portable electronic device comprises:

a main housing having opposite front and rear ends, and a top surface provided with a keyboard unit thereon, the keyboard unit including a set of control keys, each of the control keys being operable so as to enable the portable electronic device to execute a control function associated with an operated one of the control keys;

a cover body having a coupling side, and opposite first and second surfaces, the first surface being provided with a display panel thereon;

a pivot unit coupled to the rear end of the main housing and the coupling side of the cover body such that the cover body is pivotable about a longitudinal axis, which is parallel to the top surface of the main housing, and about a vertical axis transverse to the top surface of the main housing, thereby permitting operation of the portable electronic device in one of a first mode, where an angle is formed between the top surface of the main housing and the first surface of the cover body and where the cover body permits access to the keyboard unit, and a second mode, where the cover body is superimposed on the main housing such that the second surface of the cover body faces toward the top surface of the main housing and such that the cover body denies access to the keyboard unit; and

a virtual control key module for configuring the display panel to show a set of simulated control keys thereon, the simulated control keys having distinct functions assigned thereto and being available for selection so as to enable the portable electronic device to execute a control function associated with a selected one of the simulated control keys.

### BRIEF DESCRIPTION OF THE DRAWINGS

Other features and advantages of the present invention will become apparent in the following detailed description of the embodiment with reference to the accompanying drawings, of which:

FIG. 1 is a schematic side view showing a conventional portable electronic device when in a first mode of use;

FIG. 2 is a schematic side view to show that a cover body is pivotable relative to a main housing of the conventional portable electronic device;

FIG. 3 is a schematic side view showing the conventional portable electronic device when in a second mode of use;

FIG. 4 is a perspective view showing the embodiment of a portable electronic device when in a first mode of use according to the present invention;

FIG. 5 is a schematic side view to show that a cover body is pivotable relative to a main housing when the embodiment is used in the first mode;

FIG. 6 is a schematic side view showing the embodiment when in a second mode of use;

FIG. 7 is a schematic top view showing the embodiment when in the second mode of use; and

FIG. 8 is a schematic circuit block diagram of relevant components of the embodiment.

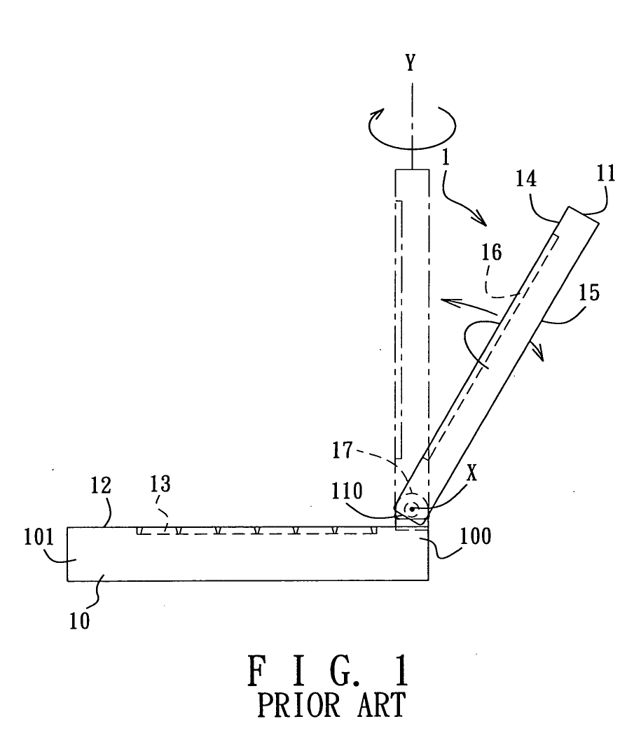

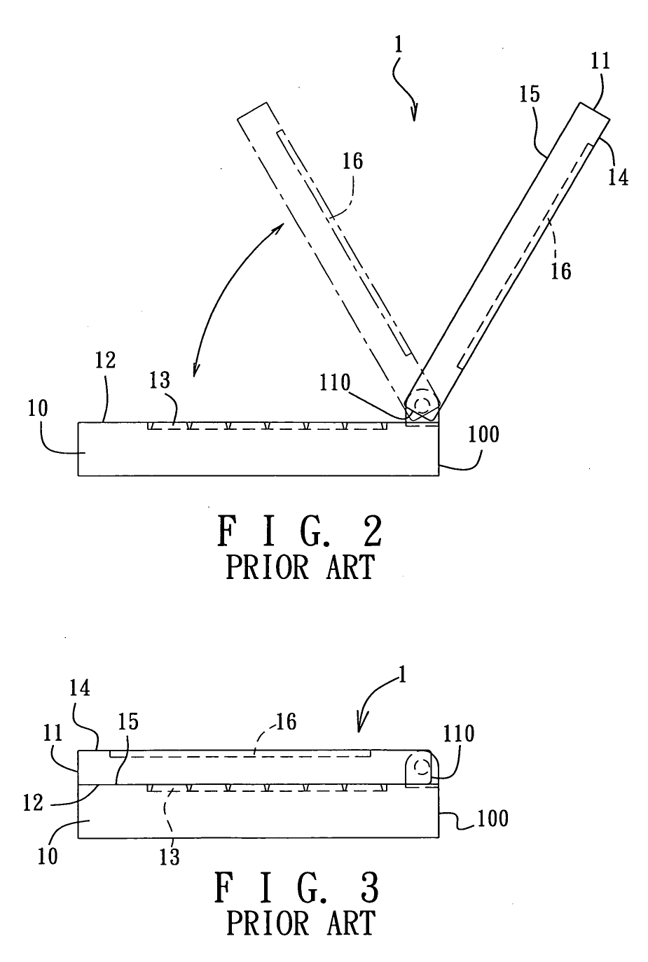

### DETAILED DESCRIPTION OF THE PREFERRED EMBODIMENT

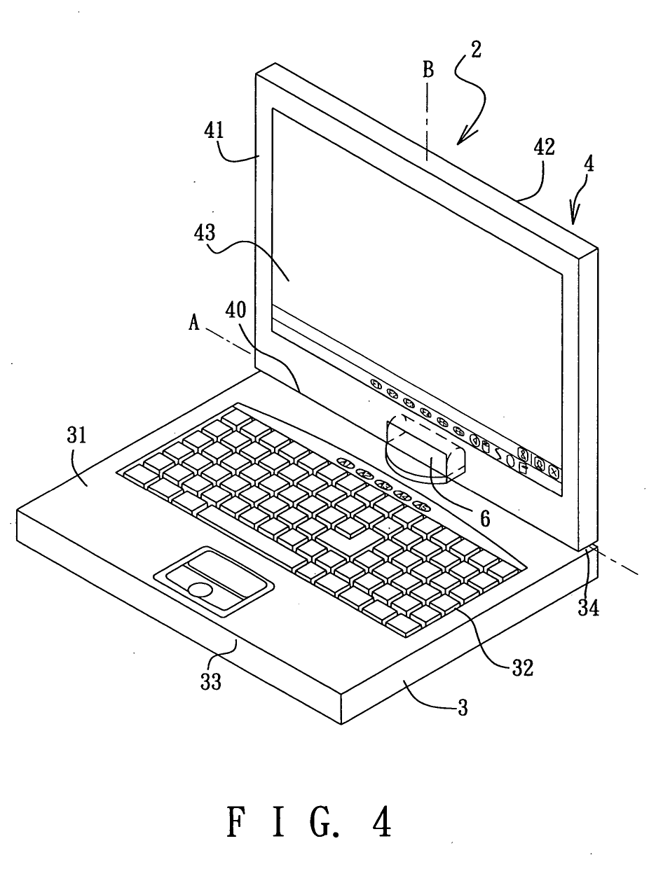

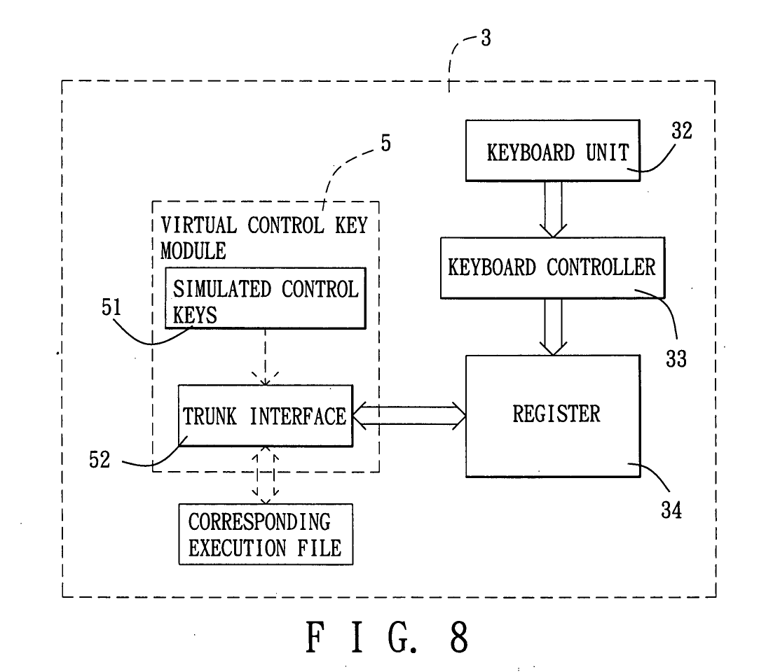

Referring to FIGS. 4 and 8, the embodiment of a portable electronic device 2, such as a notebook computer, according to the present invention is shown to include a main housing 3, a cover body 4, a pivot unit 6 and a virtual control key module 5.

The main housing 3 has opposite front and rear ends 33, 34, and a top surface 31 provided with a keyboard unit 32. In this embodiment, the keyboard unit 32 includes number keys (1, 2, 3, . . . , 0), alphabet keys (A, B, C, . . . , Z), symbol keys (<, >, +, ?, . . . ), and a set of control keys (F1˜F12, Tab, Esc, Ctrl, Shift, Home, . . . ), etc. Each control key is operable so as to enable the portable electronic device 2 to execute a control function associated with an operated one of the control keys in a conventional manner. In this embodiment, five control keys A1˜A5 are further provided on the keyboard unit 32, as shown in FIG. 4, wherein the control key A1 is operable to activate playing of multimedia, the control key A2 is operable to activate playing of a DVD, the control key A3 is operable to control sound volume, the control key A4 is operable to control brightness of a display panel 43 (to be described hereinafter), and the control key A5 is operable to initiate linking of the portable electronic device 2 to the Internet. The portable electronic device 2 further includes a keyboard controller 33 coupled electrically to the keyboard unit 32, and a register 34 coupled electrically to the keyboard controller 33 for storing operating status of an activated one of the control keys on the keyboard unit 32 and an updated control result associated with the activated one of the control keys on the keyboard unit 32 therein, as shown in FIG. 8.

The cover body 4 has a coupling side 40, and opposite first and second surfaces 41, 42. The first surface 41 is provided with a touch-control display panel 43 thereon.

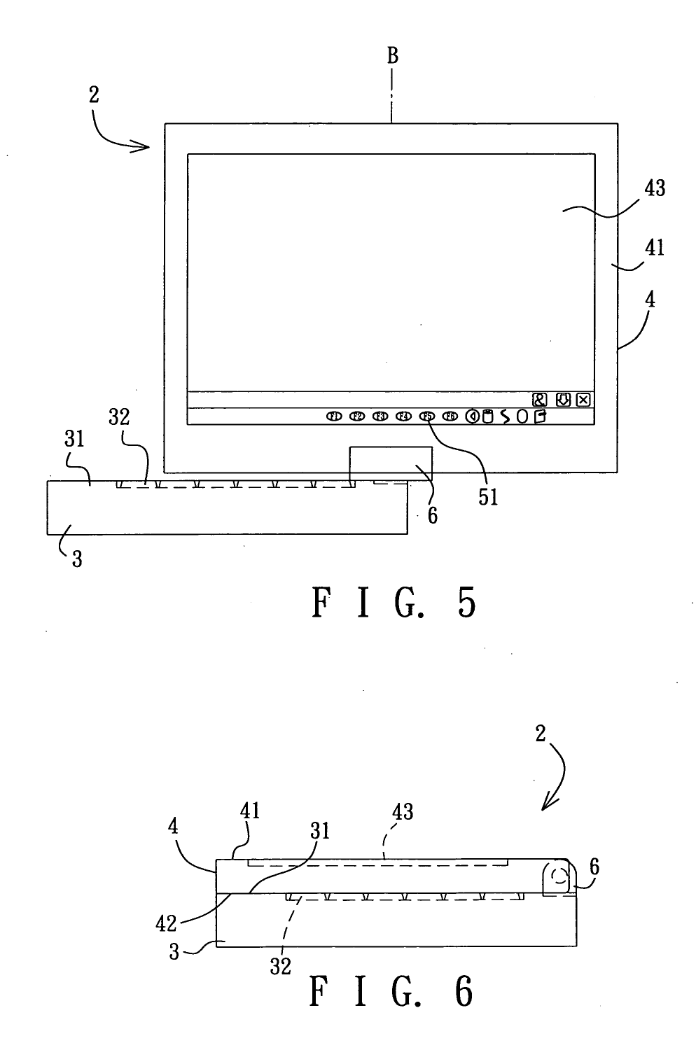

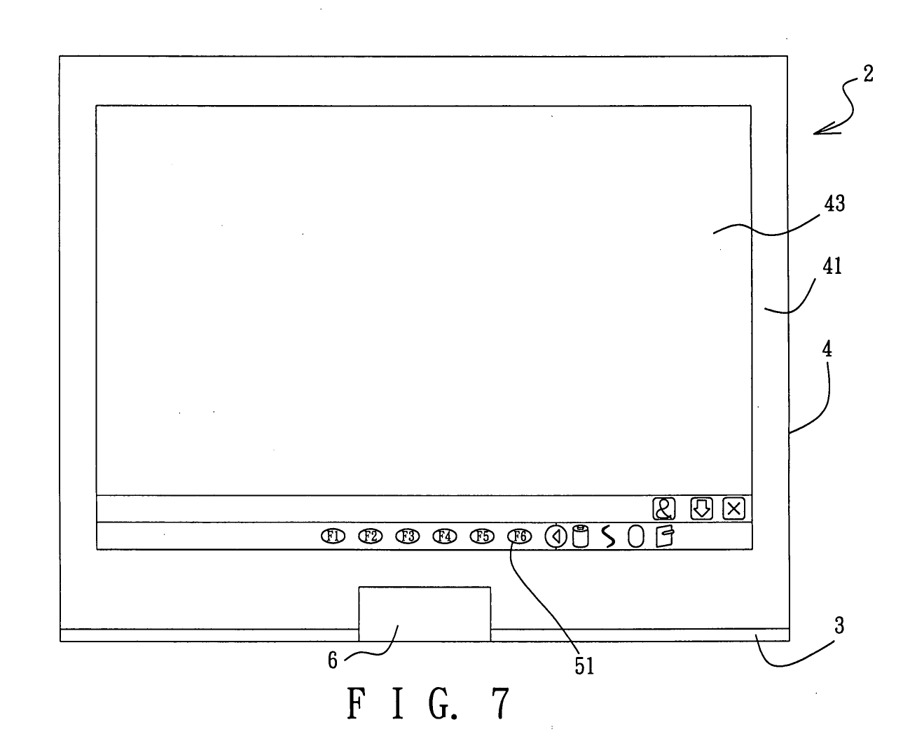

The pivot unit 6 is coupled to the rear end 34 of the main housing 3 and the coupling side 40 of the cover body 4 such that the cover body 4 is pivotable about a longitudinal axis (A), which is parallel to the top surface 31 of the main housing 3, and about a vertical axis (B) transverse to the top surface 31 of the main housing 3, as shown in FIGS. 4 and 5, there by permitting operation of the portable electronic device 2 in one of a first mode, where an angle is formed between the top surface 31 of the main housing 3 and the first surface 41 of the cover body 4 and where the cover body 4 permits access to the keyboard unit 32 (see FIG. 4), and a second (or tablet) mode, where the cover body 4 is superimposed on the main housing 3 such that the second surface 42 of the cover body 4 faces toward the top surface 31 of the main housing 3 and such that the second surface 42 of the cover body 4 denies access to the keyboard unit 32, as shown in FIG. 6. The portable electronic device 2 can serve as a tablet computer when in the second mode.

The virtual control key module 5 configures the touch-control display panel 3 to show a set of simulated control keys 51 thereon. The simulated control keys 51 have distinct functions assigned thereto and are available for selection so as to enable the portable electronic device 2 to execute a control function associated with a selected one of the simulated control keys 51. Selection among the simulated control keys 51 is possible by pressing of the touch-control display panel 43 at a location registered with a selected one of the simulated control keys 51. In this embodiment, the virtual control key module 5 is loaded with a proprietary virtual key generating program, and includes a trunk interface 52 coupled electrically to the register 34, as shown in FIG. 8. The virtual key generating program is executed so as to show the simulated control keys 51 on the display panel 43 after the portable electronic device 2 is powered on. In this embodiment, the simulated control keys 51 include simulated control keys F1˜F5 that correspond to the control keys A1˜A5 on the keyboard unit 32, respectively, and a simulated control key F6 that is configured to simulate a combination of specified control keys on the keyboard unit 32, such as a combination of Ctrl+Alt+Del. The trunk interface 52 is provided with a set of execution paths corresponding to the functions assigned to the simulated control keys 51 (i.e., the simulated control keys F1˜F6). As such, the function corresponding to a selected one of the simulated control keys F1˜F6 is executed through one of the execution paths corresponding to the selected one of the simulated control keys F1˜F6. Operating status and an updated control result associated with the selected one of the simulated control keys F1˜F6 are stored in the register 34 via said one of the execution paths corresponding to the selected one of the simulated control keys F1˜F6. Therefore, in the case that the portable electronic device 2 is operated in the second mode, when the simulated control key F1 is selected, a corresponding execution file can thus be executed through the corresponding one of the execution paths of the trunk interface 52. At the same time, the operating status of the simulated control key F1 is set to a used state that is then stored in the register 34 via the corresponding execution path of the trunk interface 52, and when the simulated control key F1 is released, the operating status of the simulated control key F1 is recovered to an unused state that is then stored in the register 34. Moreover, when the simulated control key F3 or F4 is selected, sound volume or brightness of the display panel 43 can be controlled, and the updated control result associated with the simulated control key F3 or F4 is stored in the register 34 via the corresponding execution path. It is noted that the execution paths vary according to the functions assigned to the simulated control keys 51 on the display panel 43.

Furthermore, selection among the simulated control keys 51 shown on the display panel 43 is also possible using an external mouse device (not shown) coupled electrically to the portable electronic device 2. To sum up, due to the presence of the virtual control key module 5, the portable electronic device 2 can be operated via selection of the simulated control keys 51 shown on the display panel 43 when in the second mode to thereby overcome the aforesaid drawbacks of the prior art.

While the present invention has been described in connection with what is considered a practical embodiment, it is understood that this invention is not limited to the disclosed embodiment but is intended to cover various arrangements included within the spirit and scope of the broadest interpretation so as to encompass all such modifications and equivalent arrangements.

1. A portable electronic device comprising:
a main housing having opposite front and rear ends, and a top surface provided with a keyboard unit thereon, said keyboard unit including a set of control keys, each of said control keys being operable so as to enable said portable electronic device to execute a control function associated with an operated one of said control keys;
a cover body having a coupling side, and opposite first and second surfaces, said first surface being provided with a display panel thereon;
a pivot unit coupled to said rear end of said main housing and said coupling side of said cover body such that said cover body is pivotable about a longitudinal axis, which is parallel to said top surface of said main housing, and about a vertical axis transverse to said top surface of said main housing, thereby permitting operation of said portable electronic device in one of a first mode, where an angle is formed between said top surface of said main housing and said first surface of said cover body and where said cover body permits access to said keyboard unit, and a second mode, where said cover body is superimposed on said main housing such that said second surface of said cover body faces toward said top surface of said main housing and such that said cover body denies access to said keyboard unit; and
a virtual control key module for configuring said display panel to show a set of simulated control keys thereon, said simulated control keys having distinct functions assigned thereto and being available for selection so as to enable said portable electronic device to execute the function associated with a selected one of said simulated control keys.

2. The portable electronic device as claimed in claim 1, wherein said display panel is a touch-control display panel, and selection among said simulated control keys is conducted by pressing of said touch-control display panel at a location registered with a selected one of said simulated control keys.

3. The portable electronic device as claimed in claim 1, wherein selection among said simulated control keys shown on said display panel is conducted using an external mouse device coupled electrically to said portable electronic device.

4. The portable electronic device as claimed in claim 1, further comprising a keyboard controller coupled electrically to said keyboard unit, and a register coupled electrically to said keyboard controller for storing operating status of an activated one of said control keys on said keyboard unit and an updated control result associated with the activated one of said control keys on said keyboard unit therein, and wherein said virtual control key module is loaded with a virtual key generating program for configuring said display panel to show said simulated control keys thereon when said virtual key generating program is executed, and includes a trunk interface coupled electrically to said register, said trunk interface being provided with a set of execution paths corresponding to the functions assigned to said simulated control keys;
the function corresponding to a selected one of said simulated control keys being executed through one of said execution paths corresponding to the selected one of said simulated control keys, operating status and an updated control result associated with the selected one of said simulated control keys being stored in said register via said one of said execution paths corresponding to the selected one of said simulated control keys.

5. The portable electronic device as claimed in claim 4, wherein the execution paths vary according to the functions assigned to said simulated control keys shown on said display panel.
